(19) United States
(12) Patent Application Publication
(10) Pub. No.: US 2006/0133451 A1
(43) Pub. Date: Jun. 22, 2006

(54) Use of pseudo-random frequency sequence to reduce pico-net interference in a multi-band uwb network

(76) Inventors: Dagnachew Birru, Yorktown Heights, NY (US); Jeff Bennett, Spring Valley, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/545,716

(22) PCT Filed: Feb. 9, 2004
(86) PCT No.: PCT/IB04/00326

§ 371 Date: Aug. 12, 2005

Related U.S. Application Data
(60) Provisional application No. 60/447,181, filed on Feb. 13, 2003.
(60) Provisional application No. 60/478,781, filed on Jun. 16, 2003.

(51) Int. Cl. H04B 1/69

(52) U.S. Cl. 375/130

(57) ABSTRACT

A wireless communication system and method is provided that uses a pseudo-random frequency sequence to reduce pico-net interference in a multi-band ultra wideband network. Pulse are transmitted using a pseudo-random sequence of frequencies such that neighboring pico-nets using the same technique can reduce band overlap thereby reducing mutual interference.

The present invention relates to multi-band communication systems. More particularly, the present invention relates to a system and method for reducing pico-net interference in a multi-band Ultra Wide Band network. Most particularly, the present invention relates to the use of a pseudo-random frequency sequence to reduce pico-net interference in a multi-band UWB network.

Ultra-wideband (USB) systems, utilize impulse or shock-excited, transmitter techniques in which an ultra-short duration pulse that is typically tens of picoseconds to a few nanoseconds in duration is directly applied to an output means which then sends its characteristic impulse response. For this reason, UWB is sometimes referred to as impulse radio. Further, since the excitation pulse is not modulated UWB systems are also termed zero-carrier technology. UWB communication systems operate across a wide range of spectrum relative to the center frequency which is usually achieved by transmitting pulses of short duration, typically 10-1000 picoseconds. Center frequencies range between 50 MHz and 10 GHz. The radiated energy, occupying an ultra-wide bandwidth of 100+% of the center frequency (typically measured in GHz), is often made so sufficiently small that it can co-exist with other devices without causing harmful interference to them.

Advantages of current UWB implementations include low-cost, low-power, and resilience to multi-path interference. UWB resistance to the multi-path effect derives from the fact that impulse radio signals are divided in time rather than in frequency and time-related effects, such as multi-path interference can be separated, resulting in lower average power and higher reliability for a given power level. Such benefits are typically true of the current relatively low data-rate applications where the transmitted short pulses are sufficiently separated in time.

With the adoption by the FCC of the 3.1-10.6 GHz band for UWB communication, researchers and practitioners have begun to study UWB for high data-rate (>100 Mb/s) wireless personal area network (WPAN) applications and in-building applications. Market forecasters are also forecasting millions of UWB based systems in a few years time.

Most of the UWB-related prior art implementations and research reports have been targeted to low data rate applications. Such low-data rate systems are generally designed with low pulse repetition rate. As a result, the pulse amplitude and inter-pulse distance can be made to be high. This results in the well quoted benefit of UWB, namely, resilience to interference such as multi-path interference. New applications, such as multi-media video distribution networks, require a high-data rate system, e.g. 100 Mbs to 500 Mb/s. Conventional techniques for such system require high pulse repetition rates, reducing the distance between successive pulses. This will make the UWB system prone to multi-path interference. UWB systems also need to be low cost if they are to compete well with other narrow band systems. The prior art technique of using equalizers to mitigate multi-path interference increases the cost of the UWB system.

One proposed approach for UWB systems is a multi-band modulation scheme where the total frequency band is divided into multiple bands. A corresponding impulse is then transmitted in each band. Since UWB is currently being considered for use in a WPAN environment, a straightforward multi-band approach results in interference from one pico-net to another.

Thus, there is a need for an approach to UWB communications systems that avoids multiple pico-net interference.

The system and method of the present invention provides a UWB communications system that uses a pseudo-random frequency sequence to reduce pico-net interference in a multi-band UWB network from one pico-net to another. Impulses are transmitted in a random sequence such that the probability of overlap (collision) between neighboring networks is very small.

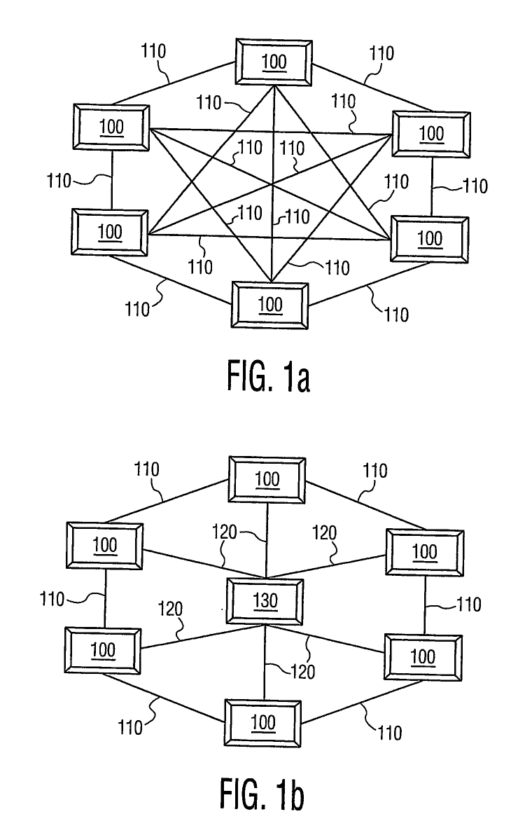

FIG. 1a illustrates a wireless network of UWB communication stations that communicate by peer-to-peer communications only;

FIG. 1b illustrates a wireless network established and controlled by a control point in which communication stations communicate through the control point as well as on a peer-to-peer basis.

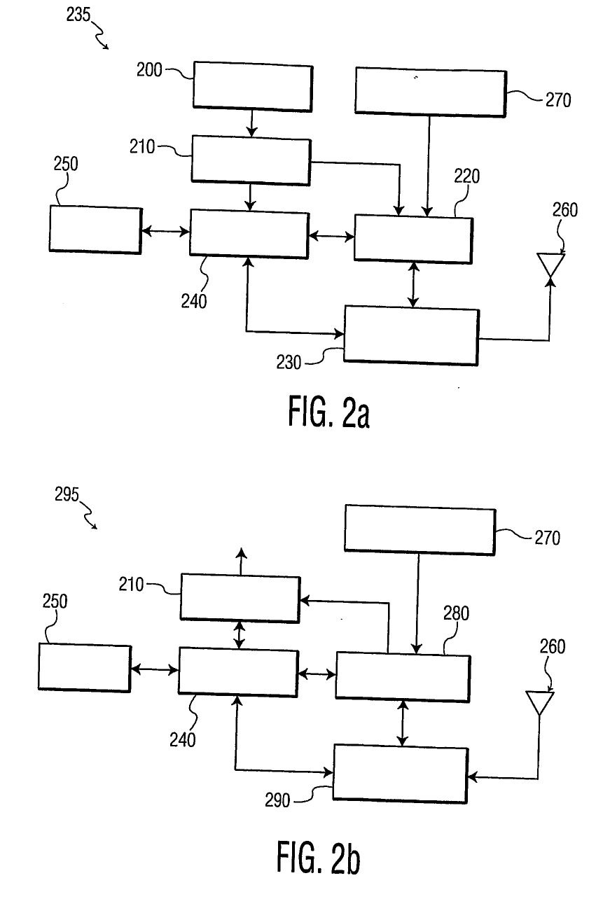

FIG. 2a is a simplified block diagram illustrating the architecture of a UWB communication station, illustrating an exemplary transmitter portion, whereto embodiments of the present invention are to be applied;

FIG. 2b is a simplified block diagram illustrating the architecture of a UWB communication stations, illustrating an exemplary receiver portion, whereto embodiments of the present invention are to be applied; and

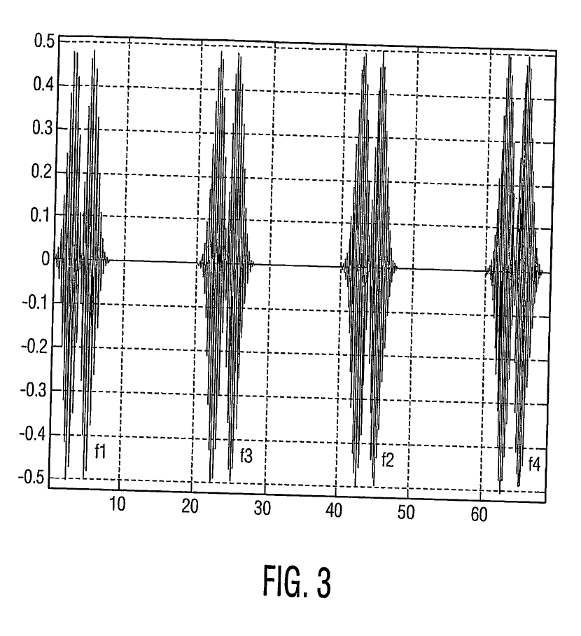

FIG. 3 illustrates multi-band pseudo-random frequency sequence UWB modulation according to the present invention.

In the following description, by way of example and not limitation, specific details are set forth such as the particular architecture, interfaces, techniques, etc., in order to provide a thorough understanding of the present invention. However, it will be apparent to one of ordinary skill in the art that the present invention may be practiced in other embodiments that depart from these specific details.

In order to communicate, UWB systems employ pulse trains as opposed to single pulses. A train (or sequence) of pulses is output for each bit of information and the pulse train is modulated so that a UWB system can communicate data. Pulse position modulation is suitable and changes the pulse repetition interval by shifting the pulse position in time forward or backward or not at all. Other modulation schemes involve digital phase modulation in which the phase of the transmitted waveform is changed with these finite phase changes representing digital data. In binary phase shift keying (BPSK) a phase modulated waveform having two changes of phase is generated which can represent two binary bits of information. With Quadrature Phase Shift Keying (QSPK), there are four changes of phase which can represent four binary bits of data, thus effectively doubling the bandwidth. Other modulation techniques include Orthogonal Frequency Division Multiplexing (OFDM), and quadrature amplitude modulation (QAM).

By way of illustration and not limitation, FIG. 1a illustrates a representative wireless network whereto embodiments of the present invention are to be applied. As shown in FIG. 1a, communication units 100 communicate on a peer-to-peer basis only through wireless links 110. FIG. 1b illustrates a representative network whereto embodiments of the present invention are also to be applied. As shown in FIG. 1b, communication units 100 communicate not only on a peer-to-peer basis through wireless links 110 but through wireless links 120 to/from a control point 130 that originally established the pico-net. A key principle of the present invention is to provide a mechanism whereby both types of UWB pico-nets of communication units 100 minimally interfere with one another when they are in proximity to one another.

FIGS. 2a-b provide an exemplary transmitter and receiver architecture, each employing an antenna. The antenna is included by way of illustration only and not in any limiting sense. Signals may be sent and received by any means, such as, via cable or an integrated circuit that can function as an antenna. The architectures of FIGS. 2a-b are included to aid in discussing and describing the present invention.

Referring now to the transmitter subsystem (235) of FIG. 2a, a wireless communication unit 100 of the UWB network of FIG. 1a or 1b may include a transmitter subsystem (235) with a transmitter architecture as illustrated in the block diagram of FIG. 2a, whereto embodiments of the present invention are to be applied. As shown in FIG. 2a, a communication unit may include an interface 200, a buffer 210, a modulator 220, a UWB wireless transmitter 230, a controller 240, a data memory 250, an antenna 260 and a pseudorandom noise source 270. The controller 240 detects the entry of an information signal into the buffer 210, and then, based on sub-band channel conditions, determines time, amplitude and phase modulations to be employed and indicates the determined modulations to the modulator 220. The exemplary system of FIG. 2a is for description. The UWB wireless transmitter 230 is coupled to antenna 260 to transmit desired data.

Referring now to the receiver subsystem (295) of FIG. 2b, a wireless communication unit 100 of the UWB network of FIGS. 1a-b may include a receiver subsystem (295) with a receiver architecture as illustrated in the block diagram of FIG. 2b, whereto embodiments of the present invention are to be applied. As shown in FIG. 2b, a communication unit may include an interface 200, a buffer 210, a demodulator 280, a UWB wireless receiver 290, a controller 240, a data memory 250, an antenna 260 and a pseudorandom noise source 270. The antenna 260 is coupled to a UWB wireless receiver 290 for receiving a propagated impulse radio signal. The controller 240 detects the receipt of a transmitted signal by the receiver 290, and then, based on sub-band channel conditions, determines time, amplitude and phase modulations that were employed and indicates the determined modulations to the demodulator 280. The exemplary system of FIG. 2b is for description purposes.

Although the description may refer to terms commonly used in describe particular transceiver systems, the description and concepts equally apply to other processing systems, including systems having architectures dissimilar to that shown in FIGS. 2a-b.

Assume that the UWB channel is divided into N bands wherein the total frequency band is divided into these N bands. In a preferred embodiment, a corresponding impulse of the train is then transmitted in each band using a pseudo-random sequence of frequencies, i.e., using a pseudo-random number sequence to select the ordering of the N bands.

For example, if there are 4 bands, each band denoted as f1, f2, f3, f4, then the sequence of pulses transmitted by one network can be f1, f3, f4, f2. Another neighboring network can then transmit using f3, f2, f4, f1. This ensures that the maximum overlap is limited to only one band, namely, f4. Nevertheless, the probability of such overlap (collision) is very small. The other bands do not overlap at all. With the conventional approach, the sequence of frequencies for all pico-nets is fixed and identical to one-another. As a result, interference in all bands is a possibility. Such interference results in reduced capacity of the overall network.

In a preferred embodiment, data is conveyed by modulating each pulse. Pulse position, binary phase shift keying (BPSK), quadrature phase shift keying (QPSK), Orthogonal Frequency Division Multiplexing (OFDM), and quadrature amplitude modulation (QAM) are among the various modulation techniques possible.

In a preferred embodiment, the order of the transmitted frequencies is known by the receiver in advance. The sequence is determined by the UWB communication unit 100 that establishes the pico-net and is communicated to each UWB communication unit 100 that joins the pico-net. It really does not matter if there is a control point, just that there is a means for each communication unit 100 to know the sequence and how to synchronize. The receiver then has knowledge of the expected frequency at a particular time. At any given moment, the receiver demodulates the signal that was sent through the known sub-band and ignores the other bands.

FIG. 3 illustrates UWB pulses where the order of the center frequency of the pulse is f1, f3, f2, f4. A neighboring network uses a different sequence of frequencies to reduce maximum collision among pico-nets. A neighboring network generates a random sequence of N numbers that is not identical to any other pico-net's sequence, to determine the sequencing of its pulses with respect to its N bands.

The example shown in FIG. 3 divides time into 80 ns periods over which the same frequency sequence is repeated. This 80 ns time is further divided into 20 ns periods for each individual frequency band. Within each 20 ns interval the pulse is modulated to convey data. However, the 80 ns period is just an example and could just as well be 300 ns or 20 ns. Further, with other modulation schemes, e.g., Orthogonal Frequency Division Multiplexing (OFDM), FIG. 3 would likely be different.

The invention may be embodied in other specific forms without departing from the spirit or essential characteristics thereof The provided embodiments are by way of example only, and are not provided in any limiting sense. The scope of the invention is indicated by the appended claims rather than by the foregoing description and all modifications coming within the meaning and range of equivalency of the claims are therefore intended to be included therein.

1. An apparatus for a multi-band ultra-wideband (UWB) communication system, comprising:
a transmitter subsystem comprising:
(a) a controller configured to divide a UWB channel into a pseudo-random sequence of N sub-bands,
(b) a modulator configured to provide a sequence of modulated pulses, and
(c) a transmitter configured to transmit each modulated pulse in said sequence through one of said sequence of N sub-bands, and
a receiver subsystem comprising-
(d) a receiver configured to receive UWB signals transmitted through said N sub-bands
(e) a controller configured to combine into a sequence of modulated pulses the signals received according to the pseudo-random sequence of said N sub-bands,and
(f) a demodulator configured to demodulate the sequence of modulated pulses.

2. The apparatus of claim 1, wherein:
said transmitter (c) further comprises means for sending selected from the group consisting of an antenna, a cable, and an integrated circuit (IC) functioning as an antenna; and
said receiver (d) further comprises means for receiving selected from the group consisting of an antenna, a cable, and an integrated circuit (IC) functioning as an antenna.

3. The apparatus of claim 1, wherein the modulator (b) is further configured to (b.1) modulate each pulse using a modulation technique from the group consisting of pulse position, binary phase shift keying (BPSK), quadrature phase shift keying (QPSK), Orthogonal Frequency Division Multiplexing (OFDM), and quadrature amplitude modulation (QAM).

4. The apparatus of claim 1, wherein:
the controller (a) is further configured to-
(a.1) repeat the frequency sequence over a predetermined time period, and
(a.2) for each frequency of the sequence, divide the predetermined time period into at least one sub-period; and
the modulator (b) is further configured to-
(b.1) modulate each pulse within the at least one sub-period to convey data.

5. The apparatus of claim 4, wherein:
the modulator (b) is further configured to-
(b.2) modulate each pulse using a modulation technique from the group consisting of pulse position, binary phase shift keying (BPSK), quadrature phase shift keying (QPSK), Orthogonal Frequency Division Multiplexing (OFDM), and quadrature amplitude modulation (QAM).

6. The apparatus of claim 4, wherein said pre-determined time period is selected from the group consisting of 20 ns, 80 ns, 300 ns and said at least one sub-period is the period divided by N.

7. The apparatus of claim 1, wherein said controller uses the transmitter to communicate the pseudo-random sequence of frequencies to a receiver subsystem such that at any given time the signal is known by the receiver subsystem to be sent through a known sub-band of said N sub-bands.

8. The apparatus of claim 7, wherein at any given time, the receiver subsystem is configured to demodulate the transmitted pulse using the communicated pseudo-random sequence of frequencies, the pulse known to be sent through the known sub-band of said N sub-bands.

9. The apparatus of claim 7, wherein the receiver subsystem is an originator of another pico-net and is configured to avoid overlap with the pico-net of the transmitter subsystem by using a different pseudo-random sequence of frequencies.

10. The apparatus of claim 1, wherein the receiver subsystem is an originator of another pico-net and is configured to avoid overlap with the pico-net of the transmitter subsystem by using a different pseudo-random sequence of frequencies.

11. A method for communicating data using ultra-wideband techniques, said method comprising:
(a) providing a transmitter subsystem configured to perform the steps of-
(a.1) dividing a UWB channel into a pseudo-random sequence of N sub-bands,
(a.2) modulating a signal as a sequence of pulses, and
(a.3) transmitting each modulated pulse in said sequence through one of said sequence of N sub-bands; and
(b) providing a receiver subsystem configured to perform the steps of:
(b.1) receiving a UWB signal transmitted through said N sub-bands,
(b.2) combining the received N sub-bands according to the pseudo-random sequence, and
(b.3) demodulating the series of UWB pulses from the combined N sub-bands.

12. The method of claim 11, wherein the transmitter subsystem is further configured to perform the steps of:
(a.4) repeating the frequency sequence over a predetermined time period;
(a.5) for each frequency of the sequence, dividing the predetermined time period into at least one sub-period; and
the modulating step (a.2) further comprises the step of
(a.2.1) modulating each pulse within the sub-period to convey data.

13. The method of claim 12, wherein the step (a.2) of modulating further comprises the step of (a.2.2) selecting a modulation technique from the group consisting of pulse position, binary phase shift keying (BPSK), quadrature phase shift keying (QPSK), Orthogonal Frequency Division Multiplexing (OFDM), and quadrature amplitude modulation (QAM).

14. The method of claim 12, wherein said pre-determined time period is selected from the group consisting of 20 ns, 80 ns, 300 ns and said at least one sub-period is the period divided by N.

15. The method of claim 11, further comprising the step of (a.6) communicating the pseudo-random sequence of frequencies to a receiver subsystem such that at any given time the signal is known by the receiver subsystem to be sent through a known sub-band.

16. The method of claim 15, further comprising the step of (c) at any given time, demodulating by the receiver subsystem the transmitted pulse using the communicated random sequence of frequencies, the pulse known to be sent through the known sub-band.
